(19) United States
(12) Patent Application Publication
(10) Pub. No.: US 2011/0310038 A1
(43) Pub. Date: Dec. 22, 2011

(54) METHOD AND APPARATUS FOR CORRECTING TOUCH COORDINATES IN TOUCH SYSTEM

(75) Inventors: Jong-Kang PARK, Suwon-si (KR); Chang-Ju LEE, Suwon-si (KR); Yoon-Kyung CHOI, Yongin-si (KR)

(73) Assignee: SAMSUNG ELECTRONICS CO., LTD., Suwon-si (KR)

(21) Appl. No.: 13/158,567

(22) Filed: Jun. 13, 2011

(30) Foreign Application Priority Data
Jun. 18, 2010 (KR) 10-2010-0058225

(51) Int. Cl. G06F 3/041

(52) U.S. Cl. 345/173

(57) ABSTRACT

A method of operating a touch system comprises storing a lookup table for correcting a touch coordinate value of a touch panel, acquiring touch data generated in response to a touch conductor on the touch panel and calculating the touch coordinate value from the acquired touch data, measuring a size of the touch conductor, and correcting the touch coordinate value by accessing the lookup table using the touch coordinate value and the size of the touch conductor as input parameters.

### CROSS-REFERENCE TO RELATED APPLICATIONS

This application claims priority under 35 U.S.C. §119 to Korean Patent Application No. 10-2010-0058225 filed on Jun. 18, 2010, the disclosure of which is hereby incorporated by reference in its entirety.

### BACKGROUND OF THE INVENTION

Embodiments of the inventive concept relate generally to display systems for electronic devices. More particularly, embodiments of the inventive concept relate to display systems comprising a touch interface such as a touch panel.

Certain electronic devices include a display having a touch interface. Such displays are commonly referred to as touch screens. The touch interface allows a user to interact with the electronic devices through the touch screen by placing an input object, such as a finger or a stylus, in proximity to the touch screen. Examples of devices that have adopted touch screens include smart phones, automated teller machines (ATMs), televisions (TVs), and home appliances, to name but a few.

In a touch interface, display coordinates, such as pixel coordinates, are generally associated with touch coordinates. In other words, when a user touches a part of the display, the touch interface generates touch coordinates that correspond to a location of the display that was touched. An accurate correspondence between display coordinates and touch coordinates allows the touch interface to accurately control the electronic device based on the user inputs.

The display can be formed using one of various technologies, such as a liquid crystal display (LCD) device, a field emission display (FED) device, an organic light-emitting display (OLED) device, or a plasma display panel (PDP) device.

The touch screen can be formed using a variety of technologies, such as resistive sensing technology, capacitive sensing technology, surface acoustic sensing technology, infrared sensing technology, a surface elastic wave sensing technology, and inductive sensing technology.

In a touch screen using resistive overlay sensing technology, a resistive material is coated on a glass or transparent plastic plate, a polyester film is covered thereon, and insulating rods are installed at regular intervals so that two sides of the polyester film do not contact each other. Then, when a user places a finger or other input object near the touch screen, it causes a resistance or a voltage of the resistive material to change. A location of the input object can be sensed according to the change of resistance or voltage. Touch screens using resistive overlay sensing technology can generally receive inputs in cursive script, but they may suffer from low transmittance and durability and an inability to perform multi-point sensing.

In a touch screen using surface acoustic wave sensing technology, a transmitter for emitting sound waves and a reflector for reflecting the sound waves at regular intervals are attached to a surface glass, and a receiver is attached to a surface opposite to the side of the glass on which the transmitter and the reflector are attached. A time at which an input object, such as a finger, interrupts a proceeding path of sound waves is used to recognize a touch point.

In a touch screen using infrared sensing technology, the linearity of infrared rays is used to detect the location of an input object. A matrix is formed by disposing an infrared light-emitting diode (LED) as a light-emitting device and a phototransistor as a light receiving device to face each other. Interception of light by an input object, such as a finger, allows the matrix to detect a location of a touch point.

Researchers continue to explore the above and other technologies in efforts to improve the performance and other capabilities of touch screen devices.

### SUMMARY OF THE INVENTION

According to one embodiment of the inventive concept, a method of operating a touch system comprises storing a lookup table for correcting a touch coordinate value of a touch panel, acquiring touch data generated in response to a touch conductor on the touch panel and calculating the touch coordinate value from the acquired touch data; measuring a size of the touch conductor, and correcting the touch coordinate value by accessing the lookup table using the touch coordinate value and the size of the touch conductor as input parameters.

According to another embodiment of the inventive concept, a touch sensing system comprises a lookup table storing unit that stores a lookup table used to correct a touch coordinate value of a touch panel, a touch data acquisition unit that acquires touch data in response to a touch on the touch panel, a processor that calculates the touch coordinate value from the acquired touch data, and measures a size of a touched conductor, and a touch coordinate value correction unit that corrects the touch coordinate value by accessing the lookup table using the touch coordinate value and the size of the conductor as input parameters.

According to another embodiment of the inventive concept, a touch interface comprises a three dimensional lookup table that maps a conductor size and a two dimensional coordinate of a touch input onto a two dimensional pixel coordinate.

These and other embodiments of the inventive concept can improve the correspondence between touch coordinate values and pixel values in touch sensing systems, and can contribute to improved performance in touch sensing systems.

### BRIEF DESCRIPTION OF THE DRAWINGS

The drawings illustrate selected embodiments of the inventive concept. In the drawings, like reference numbers indicate like features.

FIG. 1 illustrates a touch panel using mutual capacitive sensing technology.

FIG. 2 illustrates a touch panel and a signal processing unit for processing a touch signal.

FIGS. 3A and 3B illustrate variations in touch cells according to different sizes of conductors in a touch panel.

FIGS. 4A through 4C illustrate differences between real coordinate values and coordinate values acquired by a system according to different sizes of conductors in a touch panel.

FIG. 5 is a flowchart illustrating a method of correcting touch coordinate values according to different sizes of conductors in a touch panel according to an embodiment of the inventive concept.

FIG. 6 illustrates two 3D direct lookup tables for pixels of a touch panel according to an embodiment of the inventive concept.

FIG. 7 illustrates lookup tables for applying 3D interpolation to pixels of a touch panel according to an embodiment of the inventive concept.

FIG. 8 is a block diagram of a touch coordinate correction controller according to an embodiment of the inventive concept.

FIG. 9 is a block diagram of a touch system that performs a touch coordinate correction function according to an embodiment of the inventive concept.

FIG. 10 is a block diagram of a touch system comprising a touch coordinate correction controller according to an embodiment of the inventive concept.

FIG. 11 illustrates various systems that can incorporate a touch system according to embodiments of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, where a feature is referred to as being “formed on,” another feature, it can be directly formed on the other feature, or other intervening features may be present. In contrast, where a feature is referred to as being “directly formed on,” another feature, there are no intervening elements or layers present. Other words used to describe the relationship between elements or layers should be interpreted in a similar fashion (e.g., “between,” versus “directly between,” “adjacent,” versus “directly adjacent,” etc.).

Although the terms first, second, third, etc., may be used herein to describe various features, the described features should not be limited by these terms. Rather, these terms are only used to distinguish one feature from another feature. Accordingly, a first feature could alternatively be termed a second feature without departing from the scope of the inventive concept.

The terminology used herein is for the purpose of describing particular embodiments only and is not intended to be limiting of the inventive concept. As used herein, the singular forms “a”, “an” and “the” are intended to encompass the plural forms as well, unless the context clearly indicates otherwise. The terms “comprises” and/or “comprising,” where used in this description, specify the presence of stated features, but they do not preclude the presence of other features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and will not be interpreted in an idealized or overly formal sense unless expressly so defined herein.

Certain embodiments relate to capacitive touch sensing systems (CTSSs) that detect variations in capacitance values of an electrode disposed in a touch panel in response to the presence of an input object such as a finger or a conductive rod. Based on the detected variations, the CTSSs extract data from the touch panel to indicate coordinates where the input object actuated the touch panel. The touch panel typically operates using a self-capacitance method or a mutual capacitance method.

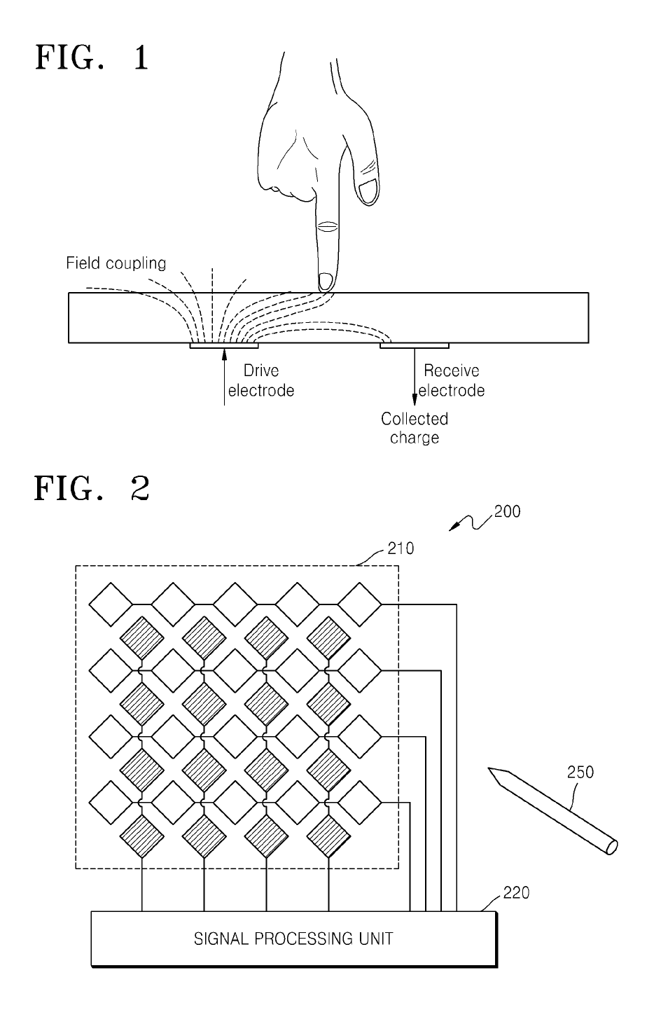

FIG. 1 illustrates a touch panel using a mutual capacitive sensing technology.

Referring to FIG. 1, a predetermined voltage pulse is applied to a drive electrode and charges corresponding to the voltage pulse are collected in a receive electrode. Where a finger is placed between the drive electrode and the receive electrodes, field coupling, indicated by dotted lines, is changed.

A system using such a touch panel senses a change in the field coupling between two electrodes, determines a touch point, and displays the touch point on a display apparatus.

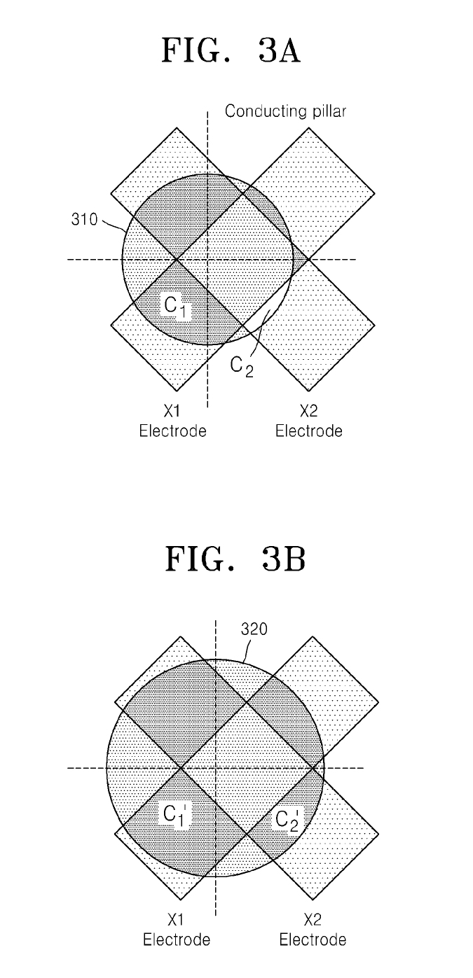

FIG. 2 illustrates a touch panel 210 and a signal processing unit 220 for processing a touch signal.

Referring to FIG. 2, a touch system 200 comprises touch panel 210, which comprises a plurality of sensing units, and signal processing unit 220, which senses a change in a capacitance of each of the sensing units of touch panel 210 in response to touch between conductor 250 and touch panel 210. Signal processing unit 220 also processes the change to generate touch data.

Touch panel 210 comprises a plurality of sensing units arranged in a row direction and a plurality of sensing units arranged in a column direction. As shown in FIG. 2, touch panel 210 comprises a plurality of rows, and a multiple sensing units are disposed in each of the rows. The sensing units disposed in each of the rows are electrically connected to one another, and thus a row forms an electrode. Touch panel 210 further comprises a plurality of columns, and multiple sensing units are disposed in each of the columns. The sensing units disposed in each of the columns are electrically connected to one another.

Signal processing unit 220 senses a change in the capacitance of each of the sensing units of touch panel 210 when conductor 250 touches touch panel 210 and generates touch data. By sensing a change in the capacitance of each of the sensing units in the plurality of rows and in the plurality of columns, signal processing unit 220 can determine whether conductor 250 touches touch panel 210 and determine a touch point.

Where conductor 250 touches touch panel 210, an actual touch point of touch panel 210 and a touch coordinate extracted by signal processing unit 220 may not correspond precisely to each other. For instance, the actual touch point and a coordinate calculated by touch system 200 may differ from each other due to shapes and densities of pixels of touch panel 210, a noise environment, and a size of conductor 250.

The CTSS generally uses a weighted average method to extract the touch coordinate. The following Equations (1) represent an example of such a weighted average method.

$$X = {\sum }_{i}^{{N}^{( x )}} {p}_{i}^{( x )} \cdot {c}_{i}^{( x ) } / {\sum }_{i}^{{N}^{( x )}} {c}_{i}^{( x )} \\ Y = {\sum }_{i}^{{N}^{( y )}} {p}_{i}^{( y )} \cdot {c}_{i}^{( y ) } / {\sum }_{i}^{{N}^{( y )}} {c}_{i}^{( y )} \qquad Equation ( 1 )$$

In Equations (1), pᵢ denotes a physical coordinate of an electrode, cᵢ denotes a touch signal sensed by the electrode, and N denotes the number of touch electrodes or channels. Coordinates X and Y are mainly determined according to a relative ratio of cᵢ. For example, suppose conductor 250 touches touch panel 210, and signal processing unit 220 extracts x touch coordinates at c^{(x)}={0, 5, 15, 7, 0}, which correspond to physical coordinates p^{(x)}={10, 20, 30, 40, 50}. With respect to touch coordinates 5, 15, and 7, which are considered to be the significant touch coordinates on the x axis, N=3, and the touch coordinate on the x axis x=20x(5/27)+30x(15/27)+40x(7/27)=30.74 according to Equations (1). That is, a maximum touch coordinate value is around physical coordinate 30, and physical coordinates 20 and 40 at both sides of physical coordinate 30 on the x axis have almost similar coordinate values 5 and 7, and thus a resultant value corresponds to a prediction that the coordinate value on the x axis is approximately 30.

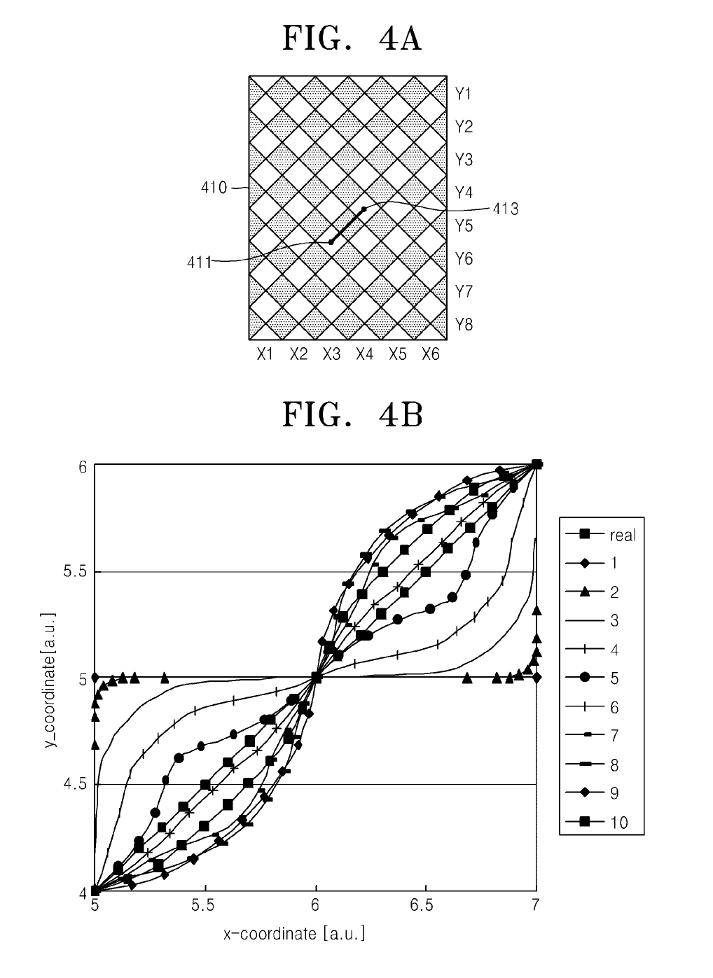

To accurately correct coordinates extracted according to Equations (1) according to the shapes and alignment of electrodes, a sensing method may take into consideration a variation in the size of a touch of conductor 250, as will be described with reference to FIGS. 3A and 3B.

FIGS. 3A and 3B illustrate variations in touch cells according to different sizes of conductors in a touch panel. In FIGS. 3A and 3B, electrodes X1 and X2 have diamond shapes in X and Y axes.

Referring to FIG. 3A, an area where a conducting pillar 310 overlaps with a center pixel of electrodes X1 and X2 is larger than other areas of overlap between conducting pillar 310 and electrodes X1 and X2. Accordingly, a touch data value acquired through the center pixel is the greatest. An area where conducting pillar 310 overlaps upper and lower parts of electrode X1 is second largest.

Referring to FIG. 3B, a conducting pillar 320 has a larger cross section than conducting pillar 310 of FIG. 3A. Sensing units of FIGS. 3A and 3B have the same sizes. Conducting pillar 320 entirely covers a center sensing unit of electrodes X1 and X2. However, an area where conducting pillar 320 overlaps upper and lower parts of electrode X1 is greater than that of conducting pillar 310 of FIG. 3A.

As illustrated by FIGS. 3A and 3B, where center coordinates of electrodes X1 and X2 are fixed and conducting pillars 310 and 320 are relatively large, c1/c2 values and c1′/c2′ values differ from each other, and thus extracted coordinate values differ, because c2′ increases more than 2 times c2, whereas c1′ does not increase more than 2 times c1. Therefore, coordinate correction values must vary according to touch areas of conducting pillars 310 and 320. In other words, to more accurately correct touch coordinates, the sizes of the conductors must be also considered.

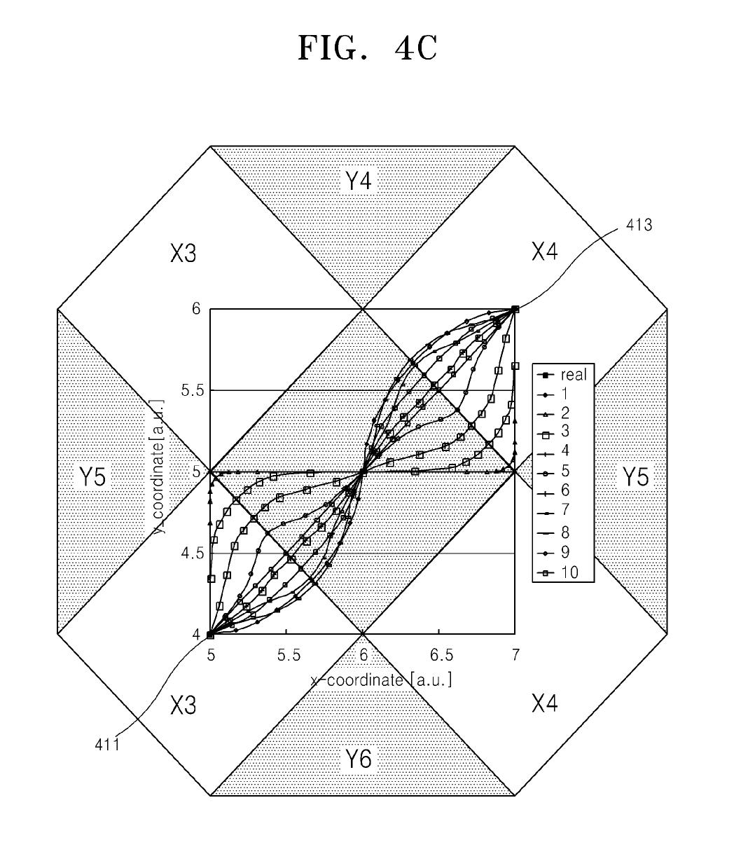

FIGS. 4A through 4C illustrate differences between real coordinate values and coordinate values acquired by a system according to different sizes of conductors in a touch panel 410 according to an embodiment of the inventive concept.

Referring to FIG. 4A, a conductor (not shown) consecutively touches touch panel 410 from a start point 411 to an end point 413. On an x axis, x electrode channels x1 through x6 are disposed, and on a y axis, y electrode channels y1 through y6 are disposed. A real x coordinate value is 5 and a real y coordinate value is 4 at start point 411, and a real x coordinate value is 7 and a real y coordinate value is 6 at end point 413.

Referring to FIG. 4B, a graph shows touch coordinate values when the conductor consecutively touches touch panel 410 and moves. “Real” values indicate real moving coordinate values with respect to sizes of conductors 1 through 10. The sizes 1 through 10 of the conductors are expressed as normalized values that are understood as comparative values. As the touch coordinates become closer to the real coordinate values, the accuracy of touch panel 410 tends to improve.

As shown in FIG. 4B, the touch coordinate value at the smallest size of conductor 1 moves 5->6->7 on the x axis and does not move on the y axis. A touch coordinate value on the y axis is not closer to a real coordinate value due to a small size of the conductor. The touch coordinate value on the y axis can reflect a touch point of the conductor, whereas a touch coordinate value on the x axis cannot reflect the touch point of the conductor.

In general, the touch coordinate values tend to become closer to the real coordinate values as the size of conductors 1->2->3->4->5 increases. Although an increase in the size of the conductor tends to increase the accuracy of touch coordinates, such an increase in the size of the conductor does not really involve an increase in the accuracy and linearity of coordinates according to the shapes of electrodes.

The graph of FIG. 4B shows that the touch coordinate value approaches the real coordinate value at the size 6 of the conductor, rather than at the sizes 9 and 10 of the conductor. When the conductor is much larger than a sensing unit of touch panel 410, the conductor touches an entire area of a plurality of sensing units, which makes it difficult to accurately determine one of the sensing units that is a center point of the conductor that touches the entire area of the sensing units. Accordingly, a relative size of the conductor may be determined with respect to the sensing units in order to correct the touch coordinate values.

The graph of FIG. 4B shows a distance between a set of coordinates having the size 8 of the conductor and a set of real coordinate values on a coordinate axis. Accordingly, where the size 8 of the conductor is known, coordinates can be corrected by mapping the coordinates to the real coordinate values in accordance with the sizes of the conductor.

Referring to FIG. 4C, variations in the touch coordinate values for the sizes of the conductor overlap on touch panel 410. That is, FIG. 4C, which is a combination of FIG. 4A and FIG. 4B, shows a process of moving the conductor from start point 411 to end point 413 on touch panel 410. Start point 411 of FIG. 4A is a lower end point of an electrode x3 and has an x coordinate value 5 and a y coordinate value 4. End point 413 of FIG. 4A ends an upper end point of an electrode x4 and has an x coordinate value 7 and a y coordinate value 6.

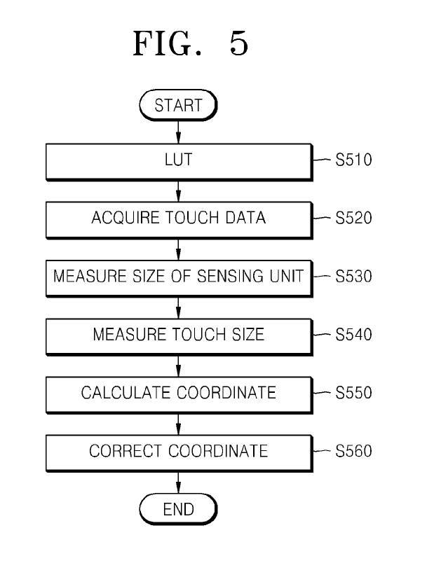

FIG. 5 is a flowchart illustrating a method of correcting touch coordinate values according to different sizes of a conductor according to an embodiment of the inventive concept.

Referring to FIG. 5, in an operation S510, a lookup table (LUT) for correcting the touch coordinate values is prepared. The lookup table is prepared from experimental data to define newly corrected values of touch coordinate values according to the size of a conductor and touch data. The lookup table is stored in a memory region of a touch system that can be accessed a relatively fast speed. The lookup table generates corrected touch coordinates under the control of a touch controller whenever a touch occurs. The lookup table, which is described in further detail below, can be a direct lookup table indicating a corrected value for each of sensing units with respect to the size of the conductor.

The amount of data in the lookup table can be significant, which can burden a memory of the touch system. Accordingly, to reduce the memory load of the touch system, a lookup table including resolutions and spaces between the size of the conductor can be prepared, and intermediate values can be acquired through interpolation. The interpolation can be 3D interpolation because the lookup table is prepared for 2D touch coordinate values and the size of the conductor.

In an operation S520, the touch controller receives touch data from a touch panel in response to a touch. Then, in an operation S530, sizes of the sensing units are measured. Next, in an operation S540, a touch size of the conductor or a conductor rod that touches the touch panel is measured.

The sizes of the conductor or the conductor rod can be measured through the touch data. For example, where touch data x1={0, 3, 11, 4, 0} and x2={0, 7, 17, 9, 0} acquired with respect to a physical coordinate value p={10, 20, 30, 40, 50} are compared to each other, although the touch data x1 and x2 are expected to have touch center points at physical coordinate value 30, the conductor has different sizes at touch data x1 and x2. In touch data x1, a sum of the touch coordinate values is 3+11+4=18. In touch data x2, a sum of the touch coordinate value is 7+17+9=33. That is, the size of the conductor by which the touch data x2 is generated is larger than that by which the touch data x1 is generated.

The size of the conductor is preferably determined through a plurality of elements of touch data rather than a single element of touch data x1 or x2 because touch directions can vary. In addition, where sizes of the sensing units of the touch panel that touches the conductor are previously known, the lookup table may be prepared with respect to relative sizes between the conductor and the sensing units. Accordingly, the sizes of the sensing units are previously measured in order to consider the relative sizes between the conductor and the sensing units. However, as described above, because the size of the conductor can be acquired from the touch data, an operation S520 of measuring the sizes of the sensing units can be omitted in certain embodiments.

After the size of the conductor and the 2D touch coordinate values for correcting touch coordinate values have been acquired, the touch coordinate values are calculated from a touch coordinate. The touch coordinate values can be calculated, for instance, using the weighted average method of Equations (1).

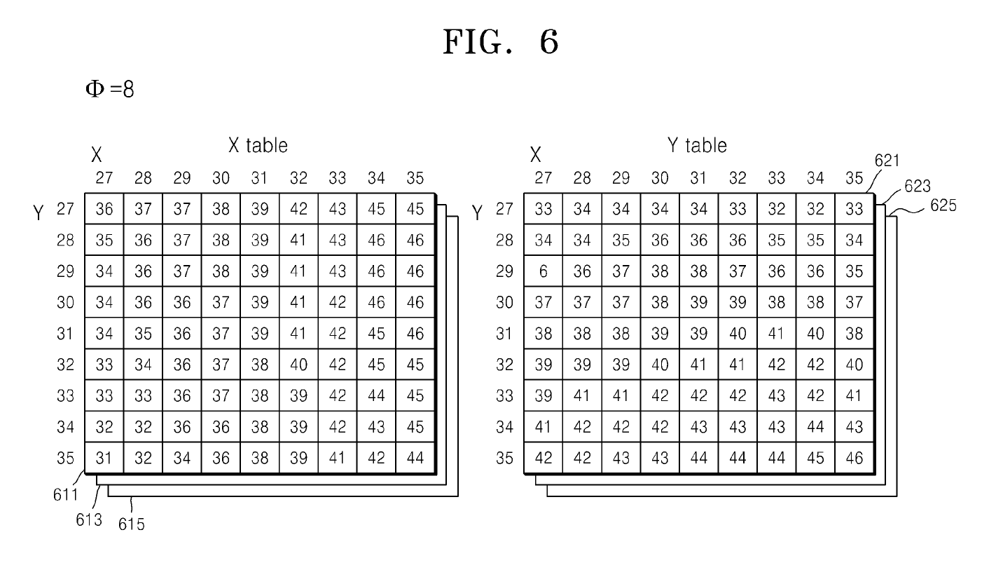

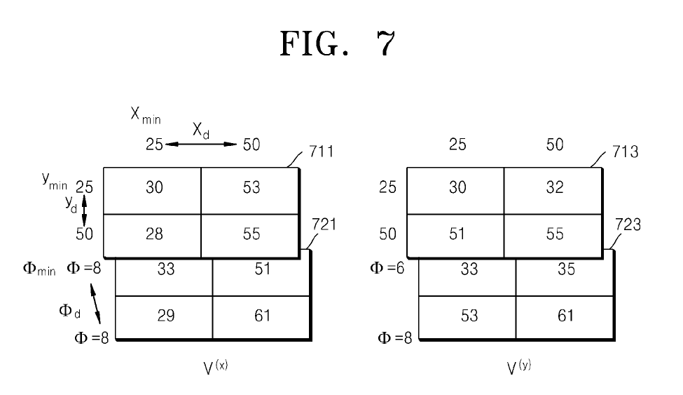

Next, in an operation S560, the touch system corrects the touch coordinate values based on the lookup table by using the touch coordinate values acquired in operation S550 and the sizes of the conductor as input parameters. A method of correcting the touch coordinate values is described below with reference to FIGS. 6 and 7.

FIG. 6 illustrates two 3D direct lookup tables for each pixel of a touch panel, according to an embodiment of the inventive concept.

Referring to FIG. 6, 3D direct lookup tables 611 and 621 are prepared to include data values for each pixel of the touch panel and various sizes of a conductor. 3D direct lookup tables 611 and 621 are on x and y axes, respectively, at a normalized size 8 of the conductor. Where the conductor has normalized sizes 9 and 10, tables 613 and 615 of x table 611 can be used to correct touch data, and tables 623 and 625 of y table 621 can be used to correct touch data.

Where touch coordinates calculated in 3D direct lookup table 611 are x=27 and y=27, and the size of the conductor is 8, corrected touch coordinates are 35 on the x axis corresponding to x=27 and y=27 of 3D direct lookup table 611 and 33 on the y axis corresponding to x=27 and y=27 of 3D direct lookup table 621. Accordingly, the corrected touch data is (35, 33). A general format of a correction function can be (x, y)_{(corrected)}=f(x, y, φ), where φ denotes a size of the conductor. For example, according to 3D direct lookup tables 611 and 621, (x, y)_{(corrected)}=f(x=32, y=33, φ=8)=(39, 42).

As an alternative to using a 3D direct lookup table that directly corresponds to all pixel values in a display, a lookup table can use interpolation to generate values for certain pixels.

FIG. 7 illustrates lookup tables for applying 3D interpolation to pixels of a touch panel according to an embodiment of the inventive concept.

Referring to FIG. 7, an x axis lookup table is for a conductor φ=6(711), 8(721) with respect to x and y coordinate values 25 and 50. A y axis lookup table is for a conductor φ=6(713), 8(723). These are part of a prepared lookup table.

It is assumed that a system includes the lookup tables for applying 3D interpolation, a calculated touch coordinate is (x, y)=(32, 45), and a size of a conductor is φ=7. The lookup tables for applying 3D interpolation have no accurately corresponding values, and so they apply 3D interpolation using neighboring values. Because x=32 between 25 and 50, y=45 also between 25 and 50, and φ=7, the lookup tables for applying 3D interpolation are appropriate. A value for substituting a general 3D interpolation is acquired according to the following Equations (2).

Xf=(X−xmin)/xd=(32−25)/25=0.28

Yf=(Y−ymin)/yd=(45−25)/25=0.8

φf=(φ−φmin)/φd=(7−6)/2=0.5 Equations (2)

In Equations (2), xmin, ymin, and φmin denote minimum values within a range for applying 3D interpolation in the lookup tables of FIG. 7 and are (25, 25, 6); xd and yd denote differences between values that are reference data for applying 3D interpolation in the lookup tables and are 50−25=25 in both x and y axes; φd=8−6=2.

A coordinate corrected by Xf, Yf, and φf acquired according to Equations (2) and lookup tables V(x) and V(y) of FIG. 7 can be acquired according to the following Equation (3).

$${X}^{′} = V ( x ) ( 25 , 25 , 6 ) * ( 1 - {X}_{f} ) * ( 1 - {Y}_{f} ) * ( 1 - {Φ}_{f} ) + V ( x ) ( 50 , 25 , 6 ) * {X}_{f} * ( 1 - {Y}_{f} ) * ( 1 - {Φ}_{f} ) + V ( x ) ( 25 , 50 , 6 ) * ( 1 - {X}_{f} ) * {Y}_{f} * ( 1 - {Φ}_{f} ) + V ( x ) ( 25 , 25 , 8 ) * ( 1 - {X}_{f} ) * ( 1 - {Y}_{f} ) * {Φ}_{f} + V ( x ) ( 50 , 25 , 8 ) * {X}_{f} * ( 1 - {Y}_{f} ) * {Φ}_{f} + V ( x ) ( 25 , 50 , 8 ) * ( 1 - {X}_{f} ) * {Y}_{f} * {Φ}_{f} + V ( x ) ( 50 , 50 , 6 ) * {X}_{f} * {Y}_{f} * ( 1 - {Φ}_{f} ) + V ( x ) ( 50 , 50 , 8 ) * {X}_{f} * {Y}_{f} * {Φ}_{f} = 36.8560 \qquad Equation ( 3 )$$

Y′=49,3560 is acquired according to Equation (3).

The interpolation according to Equation (3) is one of a variety of interpolations. An interpolation suitable for correcting touch coordinates can be used according to circumstances. The touch coordinate (32, 45) acquired according to the interpolation is corrected as (36.8560, 49.3560).

Although the interpolation of FIG. 7 may increase an amount of calculation compared to that of FIG. 6, an amount of data that is previously stored in the lookup tables is reduced compared to FIG. 6.

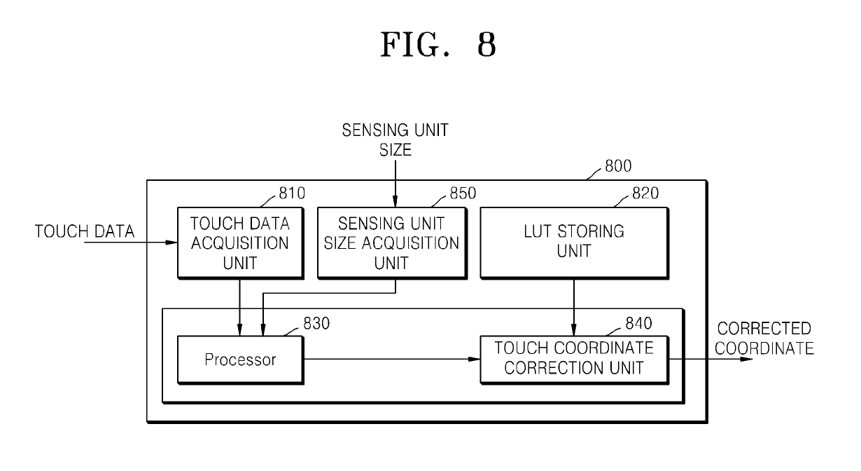

FIG. 8 is a block diagram of a touch coordinate correction controller 800 according to an embodiment of the inventive concept.

Referring to FIG. 8, touch coordinate correction controller 800 comprises a touch data acquisition unit 810, a lookup table storing unit 820, a processor 830, a touch coordinate correction unit 840, and a sensing unit size acquisition unit 850.

Touch data acquisition unit 810 acquires touch data. Touch coordinate correction controller 800 stores a lookup table in lookup table storing unit 820. The lookup table can be a 3D direct lookup table or a 3D lookup table for applying interpolation. Various types of lookup tables can be used according to applications of interpolation.

Processor 830 generates a touch coordinate value by calculating the touch data acquired by touch data acquisition unit 810 and measures a size of a conductor using the touch data as occasion requires.

Sensing unit size acquisition unit 850 acquires a size of a sensing unit and uses the sensing unit to correct the touch coordinate value. Touch coordinate correction unit 840 corrects a coordinate value using the touch coordinate value and a value of the conductor as input parameters. A size of the sensing unit is selectively used as the input parameter for correcting the coordinate value. The size of the sensing unit is referred to in order to determine the size of the conductor. Touch coordinate correction unit 840 outputs a corrected coordinate.

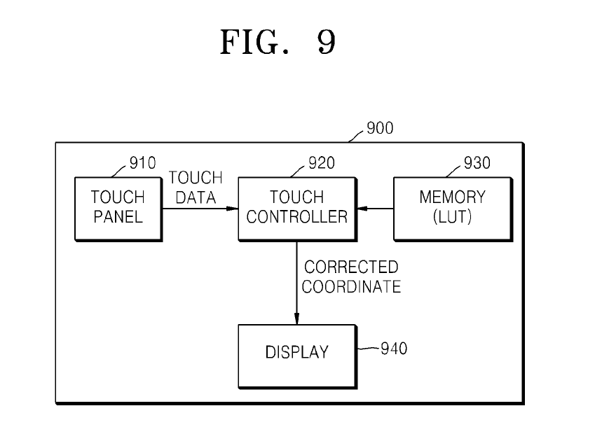

FIG. 9 is a block diagram of a touch system 900 that performs a touch coordinate correction function according to an embodiment of the inventive concept.

Referring to FIG. 9, touch system 900 sends touch data generated by a touch panel 910 to a touch controller 920 to correct the touch data. Touch controller 920 uses a lookup table stored in an internal memory (not shown) or an external memory 930. Touch controller 920 calculates a touch coordinate from the touch data sent from touch panel 910, and measures a size of a conductor from the touch data. Touch controller 920 outputs corrected touch data based on the LUT by using the touch coordinate and the size of the conductor as parameters and reflects the corrected touch data on a display 940.

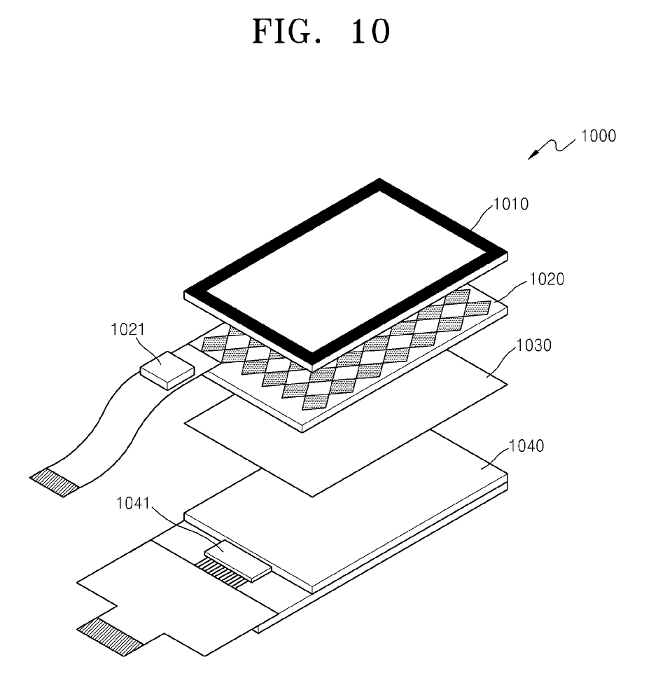

FIG. 10 is a block diagram of a touch system 1000 comprising a touch coordinate correction controller 1021 according to an embodiment of the inventive concept.

Referring to FIG. 10, touch system 1000 comprises a window glass 1010, a touch panel 1020, and a display 1040. A polarization plate 1030 for optical characteristics is further disposed between touch panel 1020 and display 1040.

Touch coordinate correction controller 1021 is mounted in the form of a chip-on-board (COB) on a flexible printed circuit board (FPCB) that is connected from touch panel 1020 to a main board. However, embodiments of the inventive concept are not limited thereto, and touch coordinate correction controller 1021 can be disposed on the main board of a graphic system.

Window glass 1010 is typically formed of a material such as acryl or tempered glass and protects a module from scratches due to an external impact or repeated touch. Touch panel 1020 is formed by patterning an electrode using a transparent electrode formed of, for example, indium tin oxide (ITO), on a glass substrate or a polyethylene terephthalate (PET) film. Touch coordinate correction controller 1021 detects a change in capacitance from each electrode, extracts a touch coordinate, performs adaptive digital filtering, and provides the filtered touch coordinate to a host controller. Display 1040 is typically formed by combining two sheets of glass consisting of an upper plate and a lower plate. A display driving circuit 1041 is attached in the form of a chip-on-glass (COG) to a mobile display panel. As another example, touch coordinate correction controller 1021 and display driving circuit 1041 can be integrated in a single semiconductor chip.

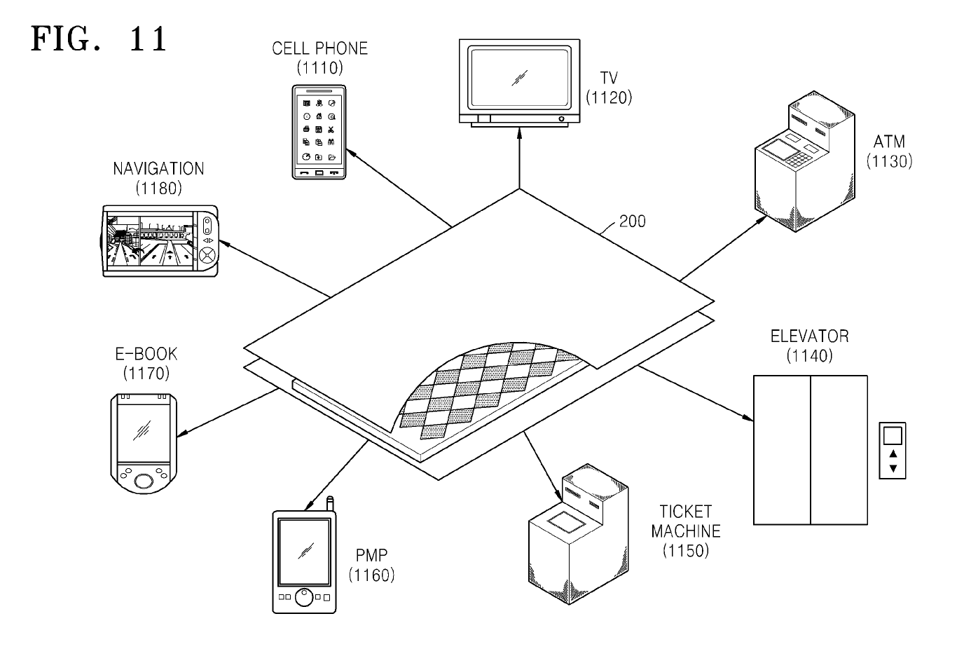

FIG. 11 illustrates various systems that can incorporate a touch system 1100 according to embodiments of the inventive concept.

Referring to FIG. 11, examples of systems that can incorporate a touch system 1100 include a cell phone 1110, a television (TV) 1120, an ATM 1130, an elevator 1140, a ticket machine 1150 such as those used in a subway, a portable multimedia player (PMP) 1160, an e-book 1170, a navigation device 1180, and so on.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A method of operating a touch system, comprising:
storing a lookup table for correcting a touch coordinate value of a touch panel;
acquiring touch data generated in response to a touch conductor on the touch panel and calculating the touch coordinate value from the acquired touch data;
measuring a size of the touch conductor; and
correcting the touch coordinate value by accessing the lookup table using the touch coordinate value and the size of the touch conductor as input parameters.

2. The method of claim 1, wherein the lookup table comprises a direct lookup value of each pixel of the touch panel to correct the touch coordinate value.

3. The method of claim 1, wherein the touch coordinate value is corrected using three dimensional (3D) interpolation of values obtained by accessing the lookup table using the touch coordinate value and the size of the touch conductor and as input parameters.

4. The method of claim 1, wherein measuring of the size of the touch conductor comprises summing magnitudes of acquired touch data.

5. The method of claim 1, further comprising determining a relative size of the touch conductor by identifying a size of a sensing unit of the touch panel.

6. The method of claim 1, wherein the touch conductor comprises a finger.

7. The method of claim 1, wherein the touch panel performs capacitive touch sensing.

8. A touch sensing system, comprising:
a lookup table storing unit that stores a lookup table used to correct a touch coordinate value of a touch panel;
a touch data acquisition unit that acquires touch data in response to a touch on the touch panel;
a processor that calculates the touch coordinate value from the acquired touch data, and measures a size of a touched conductor; and
a touch coordinate value correction unit that corrects the touch coordinate value by accessing the lookup table using the touch coordinate value and the size of the conductor as input parameters.

9. The system of claim 8, wherein the lookup table comprises a direct lookup value for each pixel of the touch panel.

10. The system of claim 8, wherein the lookup table comprises values for different touch coordinate values and different size of the conductor, and the touch coordinate value correction unit corrects the touch coordinate value using three dimensional (3D) interpolation of values accessed from the lookup table using the touch coordinate value and the size of the touch conductor as input parameters.

11. The system of claim 8, wherein the processor determines the size of the conductor through a sum of magnitudes of the acquired touch data.

12. The system of claim 8, further comprising:
a sensing unit size acquisition unit that acquires a size of a sensing unit of the touch panel to determine a relative size of the conductor.

13. The system of claim 8, wherein the conductor comprises a stylus.

14. The system of claim 8, further comprising a display coupled to the processor.

15. The system of claim 14, wherein the display comprises a liquid crystal display.

16. The system of claim 14, wherein the touch coordinate value corresponds to a pixel value of the display.

17. A touch interface, comprising a three dimensional lookup table that maps a conductor size and a two dimensional coordinate of a touch input onto a two dimensional pixel coordinate.

18. The touch interface of claim 17, further comprising a plurality of touch sensors that receive the touch input and generate the two dimensional coordinate.

19. The touch interface of claim 18, wherein the conductor size is an estimated value generated by a weighted sum of signals generated by the touch sensors.

20. The touch interface of claim 17, wherein the pixel coordinate corresponds to a location on a graphical user interface.
